(19) United States
(12) Patent Application Publication
(10) Pub. No.: US 2026/0201997 A1
(43) Pub. Date: Jul. 16, 2026

(54) COUPLING PART FOR A HYDRAULIC COUPLING

(71) Applicant: Walter Stauffenberg GmbH & Co. KG, Werdohl (DE)

(72) Inventors: Klaus LAUFER, Meinerzhagen (DE); Nikolas MAHLICH

(73) Assignee: Walter Stauffenberg GmbH & Co. KG, Werdohl (DE)

(21) Appl. No.: 19/136,967

(22) PCT Filed: Dec. 5, 2023
(86) PCT No.: PCT/EP2023/084224

§ 371 Date: Jun. 9, 2025

(30) Foreign Application Priority Data
Dec. 20, 2022 (EP) 22214874.4

(51) Int. Cl. F16L 37/40

(52) U.S. Cl. CPC F16L 37/40

(57) ABSTRACT

A coupling part for coupling to a coupling part of a coupling for pressure medium lines includes a housing having a continuous axially-running first passage, a coaxial valve tappet therein, a coaxial sleeve inner body lying in certain regions against the passage and having a cylindrical guide portion delimiting a middle second passage coaxial with the first passage, a valve sleeve axially displaceable to the inner body between first and second positions and guided through the guide portion. The sleeve is sealed relative to the body in both positions, in first position being sealed at the tappet and in second position delimiting a gap between tappet and sleeve. In first position, the body, the sleeve and the tappet delimit a flow duct. The sleeve has an interior circumferential shoulder leading into a hollow-cylindrical end portion having an inner diameter slightly smaller than the valve sleeve sliding portion outer diameter.

The invention relates to a coupling part, in particular a coupling sleeve, for coupling to a corresponding coupling part, in particular a coupling connector, for a coupling for pressure medium lines, in particular hydraulic lines, in accordance with the preamble of claim 1.

The coupling element has a valve tappet, a housing, an inner sleeve body, and a valve bushing. The housing has a continuous first passage that runs in the axial direction and forms a flow channel for a pressure medium.

Hydraulic couplings, namely a combination of a coupling sleeve and a coupling connector, serve for connecting two sections of a pressure medium line and are used, in particular, for the purpose of connecting hydraulic devices to a hydraulic source, for example for connecting a tool to an agricultural machine or a construction machine.

From the state of the art, what are called flat-sealing coupling sleeves and coupling connectors are known, which are characterized in that in the non-connected—non-coupled—state, a planar and closed surface is formed by the components of the coupling connector or of the coupling sleeve in the region of the connection interface. As a result, the entry of dirt into the housing and between the components is prevented, and the loss of pressure medium is reliably avoided. Such flat-sealing hydraulic couplings are particularly suitable for use in dirty and dusty environments.

Engagement of a hydraulic coupling, in other words the production of a shape-fit connection between a coupling sleeve and a coupling connector, usually takes place in that the coupling connector is inserted into a coupling sleeve by the user, wherein by means of the force applied by the user, not only is at least one valve, in each instance, opened so as to connect a pressure medium line on the coupling connector to a pressure medium line on the coupling sleeve, in terms of flow technology, but also a shape-fit connection is produced between coupling connector and coupling sleeve, so as to stabilize the connection, i.e., the coupled state.

Known hydraulic coupling sleeves comprise a valve tappet that is firmly arranged in the housing in the axial direction, the valve tappet head of which has a front end face, an approximately circular one. The region of the valve tappet head that faces away from the end face forms a sealing seat that can interact with a front free end of the aforementioned valve bushing, so as to close off a fluid passage through the interior of the valve bushing when the axially movable valve bushing is moved in the axial direction, from the side that faces away from the end face, in other words out of the interior of the housing in the direction toward a hydraulic coupling connector, and lies against the valve tappet.

The front region of the valve bushing, which region interacts with the valve tappet, is impacted with the hydraulic fluid from the inside, in the case of this previously known hydraulic coupling sleeve, so that this fluid can only flow over into a coupled hydraulic connector when the valve bushing is moved in the axial direction, away from the valve tappet, i.e., from its sealing seat. For this purpose, in the case of this previously known hydraulic coupling sleeve, the valve bushing is arranged to be displaceable within the housing, so that optionally the fluid passage can be opened or closed. The valve bushing forms a channel for the hydraulic fluid to be conveyed, which channel can be closed off by means of a relative movement between valve bushing and valve tappet. The valve tappet is surrounded by the hydraulic fluid.

In EP 3 574 248 B1, in the case of the previously known hydraulic coupling sleeves, it is discussed as a problem that the valve bushing, viewed in one axial direction, reportedly has a first end face having an axial surface that stands in contact with fluid of the coupling, and, in the opposite second axial direction, reportedly has a second axial end face, which end faces clearly differ. The difference between the sizes of the two axial end faces reportedly brings about a force on the valve bushing, if pressure is present, which force must be overcome when a coupling connector is introduced into the coupling sleeve. In the case of the couplings according to the state of the art, the hydraulic system would have to be shut off and made free of pressure before coupling can be carried out manually.

To eliminate the aforementioned disadvantages, it is proposed to make the axial end faces the same in both opposite directions, so as to cancel out the force resulting from a size difference of the two axial end faces. A hydraulic coupling sleeve having a corresponding solution approach is also disclosed in WO 2011/134484 A1 .

However, it proves to be a disadvantage of the hydraulic coupling sleeve proposed in EP 3 574 248 B1 and the one proposed in WO 2011/134484 that because of the same axial end faces that are strived at, the valve bushing is held in the sealing position solely by means of the spring force of a spring element connected to it. The risk exists that the valve bushing can open, in an uncontrolled manner, in the direction of the connection part, after the spring force of the valve spring has been exceeded. Such exceeding of the spring force can result from unavoidable production tolerances, as the result of which a difference in surface area in the one direction or the other cannot be avoided.

This is where the invention seeks to provide a remedy. The invention is based on the task of making available a coupling part, in particular a coupling sleeve, for coupling to a corresponding coupling part, in particular a coupling connector, of a coupling for pressure medium lines, in particular hydraulic lines, which coupling makes it possible to couple the coupling part (coupling sleeve) to a corresponding coupling part (coupling connector) without exertion of force, without the risk of uncontrolled opening of the valve bushing. According to the invention, this task is accomplished by means of a coupling part having the characteristics of claim 1.

With the invention, a coupling part, in particular a coupling sleeve, is made available for coupling to a corresponding coupling part, in particular a coupling connector, of a coupling for pressure medium lines, in particular hydraulic lines, which coupling makes it possible to couple the coupling part (coupling sleeve) to a corresponding coupling part (coupling connector) without exertion of force, without the risk of uncontrolled opening of the valve bushing. Because of the fact that the valve bushing has a circumferential shoulder on the inside, which leads into a hollow-cylindrical end section, wherein the inside diameter of the hollow-cylindrical end section is slightly smaller than the outside diameter of the sliding section of the valve bushing, it is guaranteed that the valve bushing always closes securely, wherein, however, the activation forces acting on the valve bushing are sufficiently small so that even manual coupling is possible.

The diameter difference is preferably selected to be as small as possible here, wherein the amount of the difference between the inside diameter of the hollow-cylindrical end section of the valve bushing and the outside diameter of the sliding section of the valve bushing is less than eight tenths, preferably less than four tenths, particularly preferably less than two tenths of a millimeter, and/or the circular surface enclosed by the inside diameter of the valve bushing is smaller than the circular surface enclosed by the outside diameter of the valve bushing by less than 12 mm², preferably less than 8 mm², particularly preferably less than 4 mm².

In a further development of the invention, the valve bushing, in the first position, is sealed off relative to a sealing ring that is present in a sealing groove that is arranged in the valve tappet head, by way of this ring, wherein the sealing groove is configured in such a manner that it overlaps the sealing ring by more than half of the ring's mantle surface, preferably by more than sixty percent of its mantle surface. In this way, it is prevented that the sealing ring can be brought out of its position during elevated fluid flows, when the valve is opened under pressure from one side.

In an embodiment of the invention, the sealing ring is a profile seal having a non-round, in particular a polygonal cross-section. In this way, causing the sealing ring to move out of its position is further counteracted.

In a further embodiment of the invention, a holding ring is arranged on the valve tappet, which ring forms part of the sealing groove and by way of which ring the sealing ring is held in its position. In this way, securing of the position of the sealing ring is further improved.

In a further development of the invention, the holding ring is screwed onto the valve tappet or is pressed on or shrunk on with oversize fit. In this way, easy installation of the holding ring is achieved. Alternatively, the holding ring can also be connected to the valve tappet with shape fit, in an undercut, by means of reshaping.

In an alternative embodiment of the invention, the valve bushing is sealed off relative to the valve tappet by way of a metallic seal in the first position. For this purpose, the use of a separate seal, in particular a soft seal, the position of which could possibly be brought out of its position in the case of increased fluid flows when the valve is opened under pressure from one side, is not necessary.

In a further development of the invention, the housing is formed by a base part that is connected to a connection piece. In this way, a two-part housing is achieved, and thereby the assembly of the coupling part is simplified. Preferably, the base part is screwed onto the connection piece.

In an embodiment of the invention, the inner sleeve body is held in certain regions between the base part and the connection piece. In this way, easy fixation of the inner sleeve body within the coupling part is achieved. Preferably, the inner sleeve body is sealed off relative to the connection piece by way of a seal.

In a further embodiment of the invention, the valve tappet is positioned fixed in place by way of at least one holding element, by way of which element the tappet is connected to the housing. In this regard, the holding element preferably extends in the axial direction, in certain regions, over the connection part and the inner sleeve body. In this way, the stability of the coupling part is improved.

In a further development of the invention, the at least one holding element has an axial passage opening. In this way, stable placement with a simultaneous guarantee of the fluid through-flow is made possible.

In an embodiment of the invention, a ridge that extends radially outward is arranged on the valve bushing, wherein a first spring device is arranged between this ridge and the inner sleeve body, which device is pre-stressed against the valve bushing, in the direction of the first position. In this way, a continuous press-down pressure of the valve bushing against the sealing seat of the valve tappet is achieved.

In a further embodiment of the invention, a closure bushing is arranged to encompass the valve tappet head, which bushing is arranged to be displaceable between the housing and the valve bushing, wherein at least one radial passage is introduced into the housing, in which passage a blocking ball is positioned, and a blocking ring is arranged to be displaceable on the outside of the housing, which ring extends beyond the radial passage. In this way, locking of the valve bushing in an open position is made possible.

In a further embodiment of the invention, a second spring device is arranged between the closure bushing and the inner sleeve body, which device is pre-stressed against the closure bushing, so as to hold it in its position, in which the at least one radial passage is covered by the closure bushing. In this way, unwanted locking of the valve bushing is prevented.

Other further developments and embodiments of the invention are indicated in the remaining dependent claims. Exemplary embodiments of the invention are shown in the drawings and will be described in detail below. The figures show:

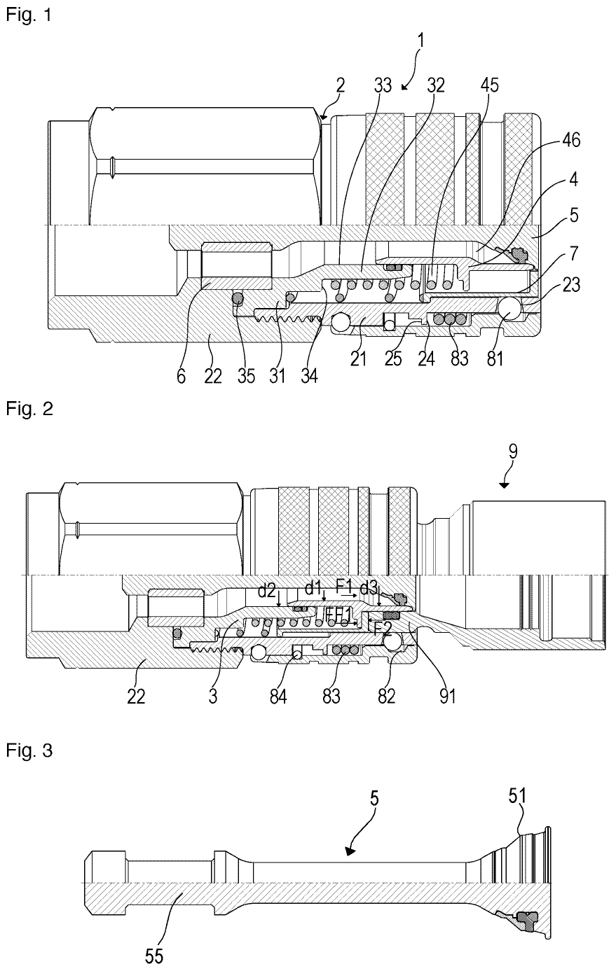

FIG. 1 the schematic representation of a coupling sleeve in partial section;

FIG. 2 the coupling sleeve from FIG. 1 with the coupling connector coupled, in partial section;

FIG. 3 the schematic representation of the valve tappet of a coupling sleeve in a second embodiment;

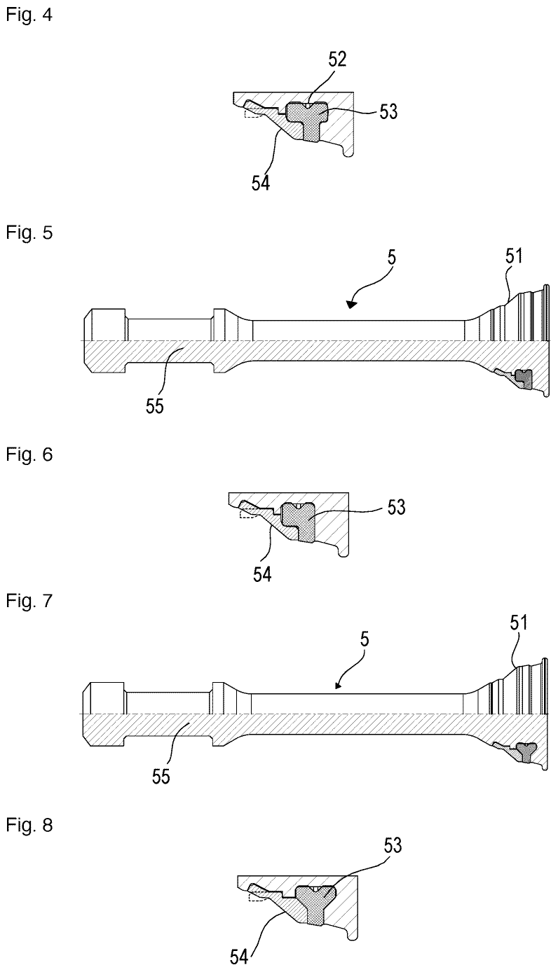

FIG. 4 the detail representation of the detail “Z” of the coupling sleeve from FIG. 3;

FIG. 5 the schematic representation of the valve tappet of a coupling sleeve in a third embodiment;

FIG. 6 the detail representation of the detail “Z” of the coupling sleeve from FIG. 5;

FIG. 7 the schematic representation of the valve tappet of a coupling sleeve in a fourth embodiment;

FIG. 8 the detail representation of the detail “z” of the coupling sleeve from FIG. 7;

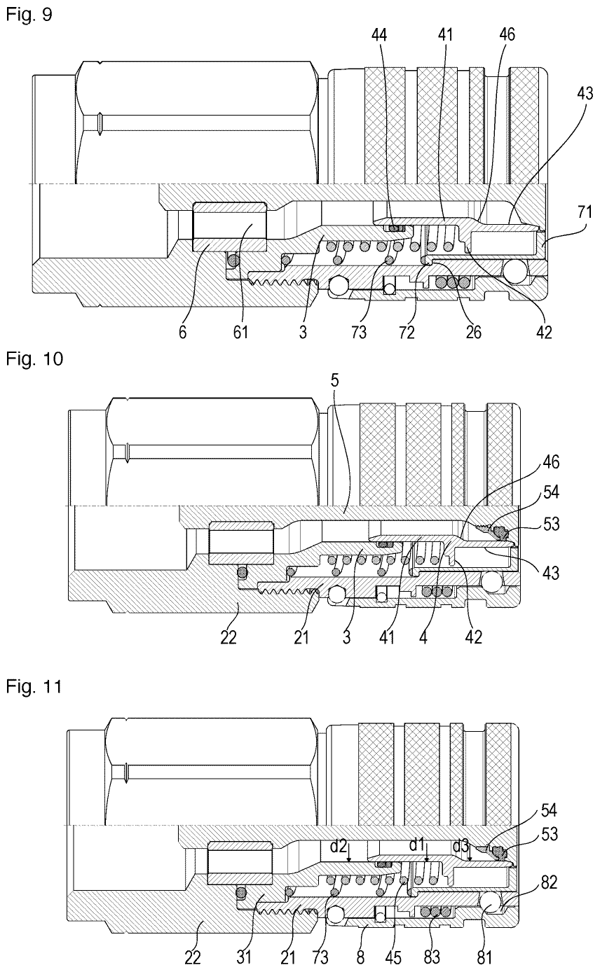

FIG. 9 the schematic representation of a coupling sleeve in a fifth embodiment;

FIG. 10 the schematic representation of a coupling sleeve in a sixth embodiment;

FIG. 11 the schematic representation of a coupling sleeve in a seventh embodiment.

The coupling part 1 according to FIG. 1 is a coupling sleeve for a hydraulic coupling, in particular a quick-release coupling on a pressure medium line that is not shown in any further detail. The coupling part 1 has a housing 2 that is formed, in the exemplary embodiment, by base part 21, which is screwed onto a connection piece 22. The housing 2 is configured to be hollow and has a first passage that runs in the axial direction.

An inner sleeve body 3, a valve bushing 4, and a valve tappet 5 are arranged in the housing 2. The inner sleeve body 3 is configured in the form of a bushing and delimits a central second passage that is arranged coaxially to the first passage. On the end side, the inner sleeve body 3 has a circumferential flange 31 that is clamped between the base part 21 and the connection piece 22 of the housing 2. On its end that lies opposite the flange 31, the inner sleeve body 3 has a guide section 32 having a cylindrical inner mantle surface 33. On the outside, the guide section in the exemplary embodiment is delimited by a shoulder 34. However, it is not compulsorily necessary that the inner guide section reaches all the way to the outer shoulder 34 in its axial expanse. The inner sleeve body 3 is sealed off relative to the connection piece 22 by way of an O-ring 35.

The inner sleeve body 3 accommodates the valve bushing 4 that is guided to be axially displaceable along the inner mantle surface of the guide section 32 of the inner sleeve body 3, with an end-side sliding section 41, and is sealed off relative to the guide section 32 by way of two O-rings 44 that are arranged next to one another. Alternatively, one O-ring 44 and a support ring positioned next to it can also be provided. The outside diameter d1 of the sliding section 41 essentially corresponds to the inside diameter d2 of the guide section 32. The sliding section 41 is delimited by a circumferential ridge 42 that projects outward and is followed by a hollow-cylindrical end section 43. The inside diameter d3 of the end section 43 of the valve bushing 4 is slightly smaller than the outside diameter dl of the sliding section 41, which latter diameter essentially corresponds to the inside diameter d2 of the guide section 32 of the inner sleeve body 3. A circumferential shoulder 46 is formed between the two different inside diameters of the valve bushing 4. In the exemplary embodiment, the inside diameter d3 of the cylindrical end section 43 of the valve bushing and the outside diameter d1 of the sliding section 41 of the valve bushing 4 have a difference from one another of d1−d3=0.1 millimeter.

The valve tappet 5 is arranged in the first passage of the housing 2, coaxial to it, and is fixed in place in the housing 2, on the end side, by way of two holding elements 6 that are arranged offset from one another by 180 degrees, in each instance. The holding elements 6 are inserted, in each instance, into a fitting grooves 55 introduced into the valve tappet 5 for this purpose, and guided, at their end section that lies opposite the valve tappet 5, between the base part 21 and the connection piece 22 of the housing 2, wherein the inner sleeve body 3 is braced between the base part 21 and the connection piece 22. To guarantee a maximal through-flow, the holding elements 6 are provided with an axial passage opening 61, in each instance. In the exemplary embodiment, the holding elements are provided as separate components. Alternatively, these can also be a single-piece component of the valve tappet 5, of the inner sleeve body 3 or of the connection piece 22. (In the case of the last two embodiments mentioned, the valve tappet 5 would have to be attached in a different way, for example screwed on.)

On its end that lies opposite the holding element 6, the valve tappet 5 has a valve tappet head 51 that is provided with a circumferential sealing groove 52, into which a sealing ring 53 having a non-round cross-section is introduced. The sealing groove 52 is supplemented with a holding ring 54, which is connected, with shape fit, to the valve tappet head 51 by means of reshaping, and covers the sealing ring in certain regions, thereby holding the latter in its position.

A pressure spring in the form of a helical spring 45 is arranged to surround the guide section 32 of the inner sleeve body 3, which spring lies against the shoulder 34 with one end and is pre-stressed against the circumferential ridge 42 of the valve bushing 4 with its opposite end. The valve bushing 4 is thereby held in a first position (closing position) by way of the helical spring 45, in which position is lies against the valve tappet head 51, forming a seal, with its end section 43, by way of the sealing ring 53.

The channel delimited by the structure described, of the components valve bushing 4, inner sleeve body 3, holding element 6, connection piece 22, and valve tappet 5, in the interior of the flat-sealing coupling sleeve 1, serves as a flow channel for the fluid.

By means of the configuration of the valve bushing 4 according to the invention, with an outside diameter d1 that is passed through the inside diameter d2 of the inner sleeve body 3, and of the recessed diameter d3 of the end section 43 of the valve bushing 4, which is a few tenths of a millimeter smaller than the diameters d2 and d3, the result is achieved that when a pressure increase occurs in the flow channel, caused by the fluid, a resulting force (F1) in the axial direction occurs, which force, together with the spring force (FF1) of the helical spring 45, presses the valve bushing 4 against the valve tappet head 51 by way of the sealing ring 53.

Furthermore, a closure bushing 7 is arranged in the housing 2, encompassing the valve tappet head 51, which bushing has a ring-shaped collar 71 that projects radially inward, and is mounted to be displaceable between the housing 2 and the valve bushing. On its end that lies opposite the collar 71, the closure bushing 7 has a circumferential ridge 72 that projects outward. A pressure spring in the form of a helical spring 73 is arranged between the flange 31 of the inner sleeve body 3 and the locking bushing 7, by way of which spring the closure bushing 7 is held in its end position, in which the ridge 71 lies in a plane with the valve tappet head 51 and lies against a shoulder 26 arranged on the inside, on the base part 21 of the housing 2, with its collar 72. In this position, the closure sleeve 7 covers radial passages 23 introduced circumferentially in the base part 21 of the housing 2, which passages are configured to narrow conically and in which passages a blocking ball 81 is positioned, in each instance.

On the outside of the base part 21, a blocking bushing 8 is displaceably arranged, which bushing has a circumferential groove 82 on the inside, for holding a section of the blocking balls 81. The blocking bushing 8 is pre-stressed against the blocking balls 81 by way of a helical spring 83 that lies against a shoulder 24 of the base part 21. At a distance from the helical spring 83, a securing ring 84 is introduced on the inside, in the blocking bushing 8. The securing ring 84, in interaction with a stop 25 arranged on the outside on the base part 21, delimits the axial movement of the blocking bushing 8 along the base part 21.

During coupling, in other words for production of a mechanical and fluidic connection between the coupling part 1 and a coupling connector 9, the closure bushing 7 is pushed, during the coupling process, through a ring-shaped formation 91 arranged on the coupling connector 9, against the spring force of the helical spring 73, in the direction of the ridge 42 of the valve bushing 4, until the collar 71 lies against this ridge 42 (see FIG. 2). Then the valve bushing 4 is moved along by way of the ridge 42, against the spring force of the helical spring 45, thereby forming a gap between the valve bushing 4 and the sealing ring 53. By way of this gap, the fluid, which is under pressure, can escape into the flow channel of the coupling connector 9 at a high flow velocity. In this regard, the holder ring 54 attached to the valve tappet head 51 prevents that the sealing ring 53 remains in its position and is not carried away by the flow.

By means of the displacement of the closure bushing 7, the passages 23 of the base part 2 are released, and thereby the blocking balls 81 positioned in these passages pass through the passages 23 with a spherical section. In this position, the blocking balls 81 no longer project inward out of the passages 23, and therefore the blocking bushing is moved over the passages 23 by means of the spring pre-stress of the helical spring 83, until the securing ring 84 lies against the stop 25 of the base part 21.

In FIGS. 3 to 11, exemplary embodiments having different sealing arrangements for sealing off the end section 43 of the valve bushing 4 and the valve tappet head 51 are shown. The combination of sealing groove 52 and holding ring 54 (not present in the exemplary embodiment according to FIG. 9) allows a cavity to form for the sealing ring 53, into which cavity the sealing ring 53 can be fitted, optimally with shape fit, with its geometry, which is non-round, in each instance. In this regard, the holding ring 54 can be connected to the valve tappet head 51, with shape fit, into an undercut of the head, for example by means of shaping (see FIGS. 1 to 8), can be screwed onto the head (see FIG. 10), or also be shrunk onto the head with an excess-dimension fit (see FIG. 11). Alternatively to the placement of a sealing ring, a metallic sealing surface can also be provided between the valve tappet head 51 and the end section 43 of the valve bushing 4.

During uncoupling, in other words for release of the mechanical and fluidic connection between the coupling part 1 and a coupling connector 9, the blocking bushing 8 is displaced against the spring force of the helical spring 83 so far until the groove 82 is positioned above the passages 23 of the base part 21. By means of the spring force of the helical spring 45, the valve bushing 4 is pressed, with its end section 43, against the valve tappet head 51, where it is sealed off relative to the valve tappet head 51 by means of the sealing ring 53. At the same time, the closure bushing 7 is moved into its starting position by means of the spring force of the helical spring 73, where it lies against the shoulder 26 of the base part 21 with the circumferential ridge 72. In this regard, the coupling connector 9 is moved out of the coupling part 1 with its formation 91. At the same time, the blocking balls 81 are moved radially completely into the passages 23, and the groove 82 of the blocking bushing 8 that is positioned over these passages is moved. The uncoupling process has now been concluded; the blocking bushing can be let go, and after this happens the bushing is pressed against the sections of the blocking balls 81 that project into the groove 82, as the result of the spring force of the helical spring 83.

1. A coupling part (1), in particular a coupling sleeve, for coupling to a corresponding coupling part, in particular a coupling connector (9), of a coupling for pressure medium lines, in particular hydraulic lines, comprising
a housing (2) having a continuous first passage that runs in the axial direction,
a valve tappet (5) that is coaxially arranged in the first passage of the housing (2),
an inner sleeve body (3) that is coaxially arranged in the first passage of the housing (2), lying against it in certain regions, and having a cylindrical guide section (32) by means of which a central second passage is delimited, which is arranged coaxial to the first passage,
a valve bushing (4) that is arranged to be displaceable in the axial direction, between a first position and a second position, relative to the inner sleeve body (3), through the guide section (32) of which body the bushing is guided, wherein the valve bushing (4) forms a seal relative to the inner sleeve body (5) both in the first position and in the second position, and in the first position forms a seal on the valve tappet (5) and in the second position delimits a gap between the valve tappet (5) and the valve bushing (4),
wherein in the first position of the valve bushing (3), a flow channel is delimited by the inner sleeve body (3), the valve bushing (4), and the valve tappet (5), wherein the valve bushing (4) has a circumferential shoulder (46) on the inside, which leads into a hollow-cylindrical end section (43), wherein the inside diameter (d3) of the hollow-cylindrical end section (43) is slightly smaller than the outside diameter (d1) of the sliding section (41) of the valve bushing (4).

2. The coupling part according to claim 1, wherein the amount of the difference between the inside diameter (d3) of the hollow-cylindrical end section (43) of the valve bushing (4) and the outside diameter (d1) of the sliding section (41) of the valve bushing (4) is less than eight tenths, preferably less than four tenths, particularly preferably less than two tenths of a millimeter.

3. The coupling part according to claim 1, wherein the circular surface enclosed by the inside diameter (d3) of the valve bushing (4) is smaller than the circular surface enclosed by the outside diameter (d1) of the valve bushing (4) by less than 12 mm², preferably less than 8 mm², particularly preferably less than 4 mm².

4. The coupling part according to claim 1, wherein the valve bushing (4), in the first position, is sealed off relative to a sealing ring (53) that is present in a sealing groove (52) that is arranged in the valve tappet head (51), by way of the sealing ring, wherein the sealing groove (52) is configured in such a manner that it the sealing groove (52) overlaps the sealing ring (53) by more than half of the ring's mantle surface, preferably by more than sixty percent of its mantle surface.

5. The coupling part according to claim 4, wherein the sealing ring (53) is a profile seal having a non-round cross-section.

6. The coupling part according to claim 4, wherein a holding ring (54) is arranged on the valve tappet (5), wherein the holding ring forms a part of the sealing groove (52) and holds the sealing ring (53).

7. The coupling part according to claim 6, wherein the holding ring (54) is screwed onto the valve tappet (5) or is pressed on or shrunk on with oversize fit.

8. The coupling part according to claim 6, wherein the holding ring is connected to the valve tappet (5) with shape fit, by means of reshaping.

9. The coupling part according to claim 1, wherein the valve bushing (4) is sealed off in the first position, relative to the valve tappet (5), by way of a metallic seal.

10. The coupling part according to claim 1, wherein the housing (2) is formed by a base part (21) that is connected to a connection piece (22), preferably screwed onto it the connection piece (22).

11. The coupling part according to claim 10, wherein the inner sleeve body (3) is held in certain regions between the base part (21) and the connection piece (22).

12. The coupling part according to claim 11, wherein the inner sleeve body (3) is sealed off relative to the connection piece by way of a seal.

13. The coupling part according to claim 1, wherein the valve tappet (5) is positioned fixed in place by way of at least one holding element (6), by way of the at least one holding element the tappet is connected to the housing (2).

14. The coupling part according to claim 13, wherein the holding element (6) extends in the axial direction, in certain regions, over the connection part (22) and the inner sleeve body (3).

15. The coupling part according to claim 13, wherein the at least one holding element (6) has an axial passage opening (61).

16. The coupling part according to claim 1, wherein a ridge (42) that extends radially outward is arranged on the valve bushing (4), wherein a first spring device is arranged between the ridge (42) and the inner sleeve body (3), wherein the first spring device is pre-stressed against the valve bushing (4), in the direction of the first position.

17. The coupling part according to claim 1, wherein a closure bushing (7) is arranged to encompass the valve tappet head (51), wherein the closure bushing is arranged to be displaceable between the housing (2) and the valve bushing (4), wherein at least one radial passage (23) is introduced into the housing (2), wherein a blocking element, preferably a blocking ball (81) is positioned in the at least one radial passage (23), and a blocking ring (8) is arranged to be displaceable on the outside of the housing (2), wherein the blocking ring extends beyond the radial passage (23).

18. The coupling part according to claim 17, wherein a second spring device is arranged between the closure bushing (7) and the inner sleeve body (3), wherein the second spring device is pre-stressed against the closure bushing (7), so as to hold the closure bushing (7) in a position in which the at least one radial passage (23) is covered by the closure bushing (7).
